(19) United States
(12) Patent Application Publication
(10) Pub. No.: US 2026/0284909 A1
(43) Pub. Date: Sep. 24, 2026

(54) FAIL-SAFE ELECTROMAGNETIC TOOL CHANGER SYSTEM AND APPARATUS

(71) Applicant: Trilobio, Inc., San Francisco, CA (US)

(72) Inventors: Maximilian Eugene SCHOMMER, Huntington Beach, CA (US); Scott Hillman MACKINLAY, San Francisco, CA (US)

(73) Assignee: Trilobio, Inc., San Francisco, CA (US)

(21) Appl. No.: 19/476,577

(22) PCT Filed: Apr. 17, 2024
(86) PCT No.: PCT/US2024/025007

§ 371 Date: Oct. 17, 2025

Related U.S. Application Data
(60) Provisional application No. 63/460,218, filed on Apr. 18, 2023.

(51) Int. Cl. B25J 15/04; B25J 19/00; G01N 35/00

(52) U.S. Cl. CPC B25J 15/0441; B25J 19/0041; G01N 35/0099

(57) ABSTRACT

A tool changer system includes a robot arm, an electromagnetic adhesion system, and a kinematic mount alignment system. The robot arm includes a rotating component and a controller that adjusts an electrical current. The electromagnetic adhesion system includes an electromagnetic tool changer. The electromagnetic tool changer includes a permanent electromagnet that produces a magnetic field in an absence of the electrical current and cancels a produced magnetic field in response to a particular value of the electrical current. The permanent electromagnet is sized and shaped for coupling with a tool changer receiver mounted to a modular tool. The kinematic mount alignment system includes a plurality of tool changer alignment elements located on the electromagnetic tool changer. The plurality of tool changer alignment elements are sized and shaped to couple with complementary alignment elements on the tool changer receiver.

### CROSS-REFERENCE TO RELATED APPLICATIONS

The following application claims the benefit of U.S. Provisional Appl. No. 63/460,218, which is incorporated herein by reference in its entirety.

### BACKGROUND

### Field

Aspects of the present disclosure relate to biological processing systems and apparatuses, for example, tool changers that exchange modular tools.

### Background

Biological laboratory processing requires many distinct processes to be performed on a variety of samples. These processes include transferring samples from one place to another, pipetting samples, covering samples with protective lids, and many others. Additionally, it is desirable to avoid spillage and cross-contamination of samples. Because of the vast quantity of processes required, biology labs can use a robotic system for moving and placing plates containing samples in target areas for study. The robotic system will typically be responsible for moving a tool to desired positions in space, where the tool will perform its function.

Within current robotic systems, tool changers are typically used to make an automated device capable of performing a wider variety of tasks. Tool changers are designed to fulfill a challenging set of requirements. Tool changers must (1) be tolerant of a predetermined amount of misalignment in tool pick-up and drop-off routines; (2) align the tool repeatably when mounted; (3) be fail-safe, meaning that a power-off event doesn't cause the tool to drop; (4) sometimes transmit electrical power and data to the tool; and (5) be able to withstand a range of loads on the tool without failing.

To meet these requirements, current tool changers generally have two major components: (1) an alignment system; and (2) an adhesion system. The alignment system and adhesion system typically operate mechanically. Current adhesion systems use moving parts, which can make these adhesion systems costly and prone to breaking. For example, current adhesion systems include pneumatic draw bars, pneumatic ball locks, screw systems, etc. Meanwhile, current alignment systems include kinematic mounts to constrain six degrees of freedom, Jacobs Taper mounts, etc. Alignment systems do not typically need moving parts, and can consist of static components.

The characteristics of current adhesion systems and alignment systems can impose various drawbacks on current tool changers. First, the alignment system and adhesion system in current tool changers can contain multiple moving mechanical parts that can wear out, seize up, or fail. Such complicated systems can drop, damage, or destroy the biological samples if the mechanical parts fail during operation. Second, the use of mechanical parts in current tool changers makes the robotic system large and bulky. Such an inefficient use of space can impede throughput of the biological processing. Last, current tool changers can be costly because sophisticated moving mechanical parts can be expensive to manufacture and maintain.

### BRIEF DESCRIPTION OF THE DRAWINGS

The accompanying drawings, which are incorporated herein and form part of the specification, illustrate the present disclosure and, together with the description, further serve to explain the principles of the present disclosure and to enable those skilled in the relevant art(s) to make and use aspects described herein.

FIG. 1 illustrates a perspective view of a tool changer system, according to some aspects.

FIGS. 2A and 2B illustrate perspective and cross-section views, respectively, of an electromagnetic tool changer coupled to a robot arm, according to some aspects.

FIGS. 3A and 3B illustrate perspective and surface views, respectively, of an electromagnetic tool changer, according to some aspects.

FIGS. 4A and 4B illustrate perspective and top surface views, respectively, of a tool changer receiver, according to some aspects.

FIGS. 5A and 5B illustrate cross-section views of an electromagnetic tool changer mated with a tool changer receiver, according to some aspects.

FIGS. 6A and 6B illustrate perspective and bottom surface views, respectively, of a tool changer receiver, according to some aspects.

FIGS. 7A and 7B illustrate perspective and top surface views, respectively, of a modular tool, according to some aspects.

FIGS. 8A and 8B illustrate cross-section views of a tool changer receiver mated with a modular tool, according to some aspects.

FIG. 9 illustrates a method of changing a modular tool, according to some aspects.

### DETAILED DESCRIPTION

This specification discloses one or more aspects that incorporate the features of this present invention. The disclosed aspect(s) merely exemplify the present invention. The scope of the invention is not limited to the disclosed aspect(s). The present invention is defined by the claims appended hereto.

The aspect(s) described, and references in the specification to “one aspect,” “an aspect,” “an example aspect,” “an exemplary aspect,” etc., indicate that the aspect(s) described may include a particular feature, structure, or characteristic, but every aspect may not necessarily include the particular feature, structure, or characteristic. Moreover, such phrases are not necessarily referring to the same aspect. Further, when a particular feature, structure, or characteristic is described in connection with an aspect, it is understood that it is within the knowledge of one skilled in the art to effect such feature, structure, or characteristic in connection with other aspects whether or not explicitly described.

Spatially relative terms, such as “beneath,” “below,” “lower,” “above,” “on,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

The term “about” or “substantially” or “approximately” as used herein indicates the value of a given quantity that can vary based on a particular technology. Based on the particular technology, the term “about” or “substantially” or “approximately” can indicate a value of a given quantity that varies within, for example, 1-15% of the value (e.g., ±1%, ±2%, ±5%, ±10%, or ±15% of the value).

### Example Tool Changer System

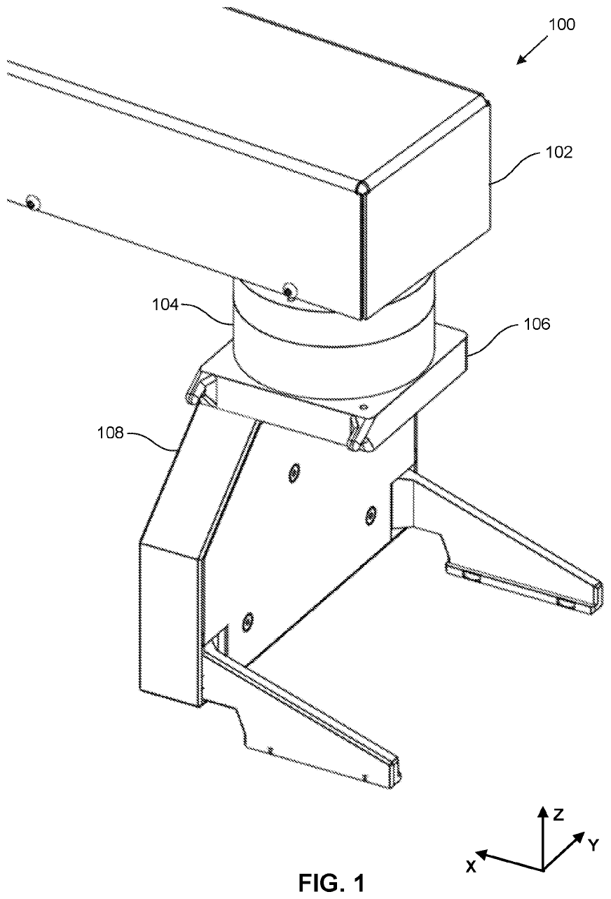

FIG. 1 illustrates a perspective view of a tool changer system 100, according to some aspects. Tool changer system 100 can include a robot arm 102, an electromagnetic tool changer 104, a tool changer receiver 106, and a modular tool 108.

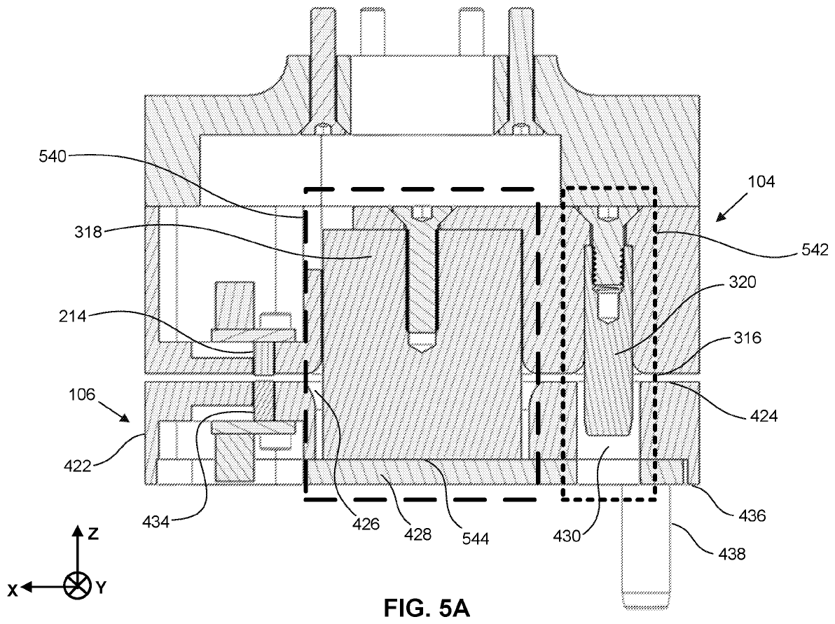

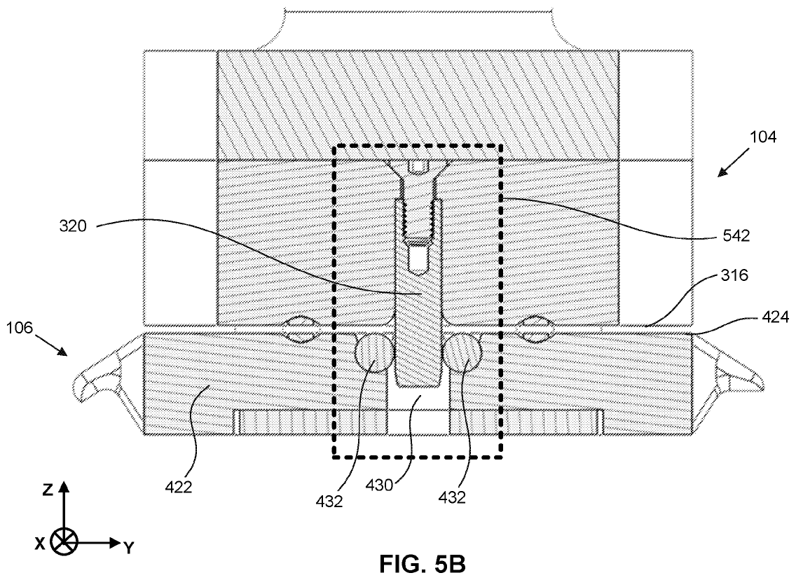

In some aspects, tool changer system 100 can use electromagnetic tool changer 104 and tool changer receiver 106 as components in an electromagnetic adhesion system and a kinematic mount alignment system (as shown in and further described with respect to FIGS. 5A-5B) for securing modular tool 108 to robot arm 102.

In some aspects, robot arm 102 can be coupled to a chassis, such as an overhead support structure. Robot arm 102 can be an articulable manipulator capable of movement in some or all directions. This configuration can allow robot arm 102 to move along a platform deck containing objects (e.g., biological samples) and access each object. Robot arm 102 can then move in a vertical direction (i.e., towards and away from the chassis) via an extension and retraction system internal to robot arm 102. In this way, robot arm 102 can reach any location on or within the volume of the chassis. In some aspects, the chassis may have a cuboid shape (e.g., cube, rectangular prism, trapezoidal prism, and the like) having a volume, such as a deck with an overhead and/or side support structure as described in PCT Appl. Publ. WO 2023/173038, which is incorporated by reference herein in its entirety.

In some aspects, one or more modular tools 108 may be located on (e.g., mounted to), within the volume of, or near the chassis supporting robot arm 102. For example, the chassis supporting robot arm 102 may contain a tool storage support containing tools not currently in use by robot arm 102. In some aspects, robot arm 102 can be equipped with electromagnetic tool changer 104 that enables robot arm 102 to interact with modular tools 108 located on, within the volume of, or near the chassis supporting robot arm 102. For example, robot arm 102 can place, insert, or otherwise connect electromagnetic tool changer 104 to tool changer receiver 106 mounted on modular tool 108, in order to secure modular tool 108. In some aspects, robot arm 102 can be configured to remove and replace one of the modular tools 108 from the chassis (e.g., from the tool storage support located thereon) with the use of electromagnetic tool changer 104. Therefore, robot arm 102 can be configured to move a modular tool 108 to a location on or within a biological processing environment.

In some aspects, a top surface of electromagnetic tool changer 104 can be coupled to robot arm 102 and a bottom surface of electromagnetic tool changer 104 can be removably coupled to tool changer receiver 106. In some aspects, electromagnetic tool changer 104 and tool changer receiver 106 can mate and align to perform adhesion and alignment functions within tool changer system 100.

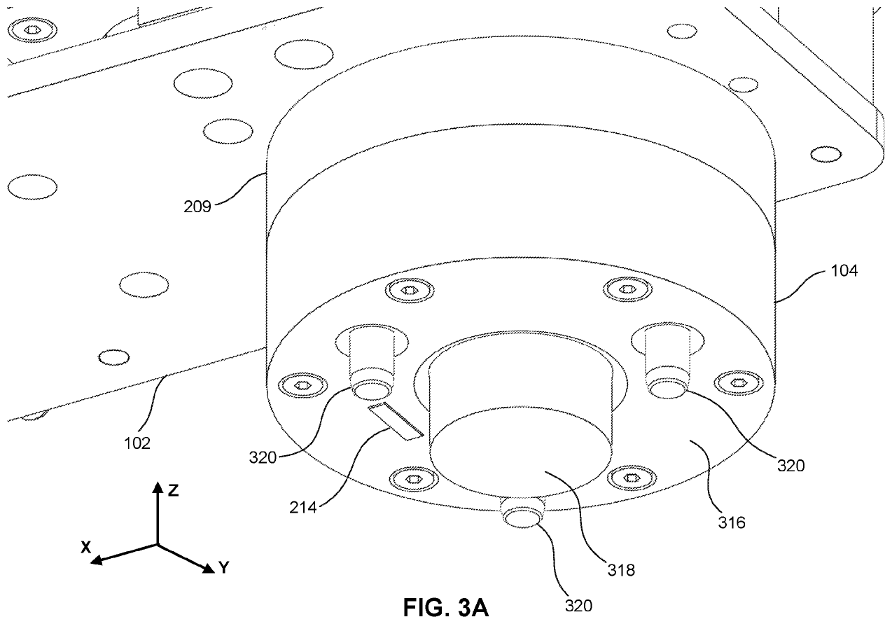

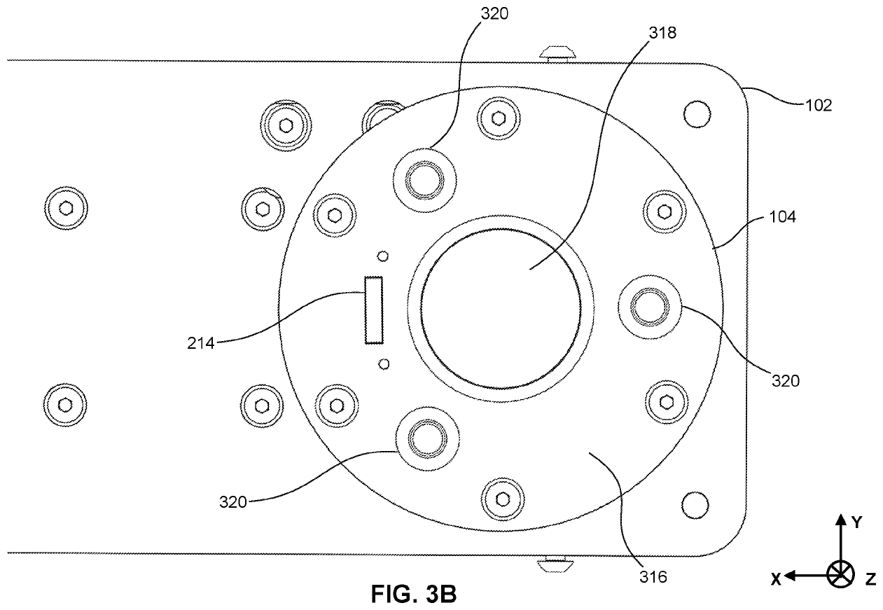

In some aspects, electromagnetic tool changer 104 can contain a permanent electromagnet configured to magnetically adhere to tool changer receiver 106 as part of an electromagnetic adhesion system within tool changer system 100 (as shown in and further described with respect to FIGS. 3A-3B and 5A-5B). In some aspects, the permanent electromagnet in electromagnetic tool changer 104 is configured to provide a magnetic field in the absence of power, while an applied current can be used to either change the strength of the magnetic field or cancel the magnetic field altogether. In some aspects, because of the permanent electromagnet, electromagnetic tool changer 104 can provide a fail-safe function within tool changer system 100—when an unexpected power-off event occurs, electromagnetic tool changer 104 can maintain adhesion with tool changer receiver 106 to prevent modular tool 108 from dropping. While this disclosure addresses adhesion functions for tool changer 104, a skilled artisan will recognize that aspects of this disclosure can be used in a variety of tool holders, applicators, etc., both static and mobile, such as robotic arms, tool storage mounts, transfer plates, execution systems, etc.

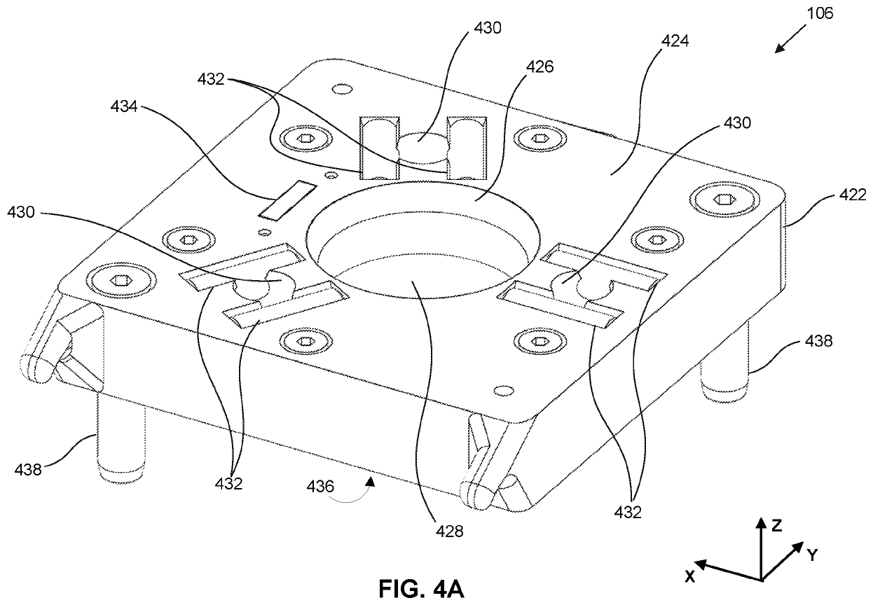

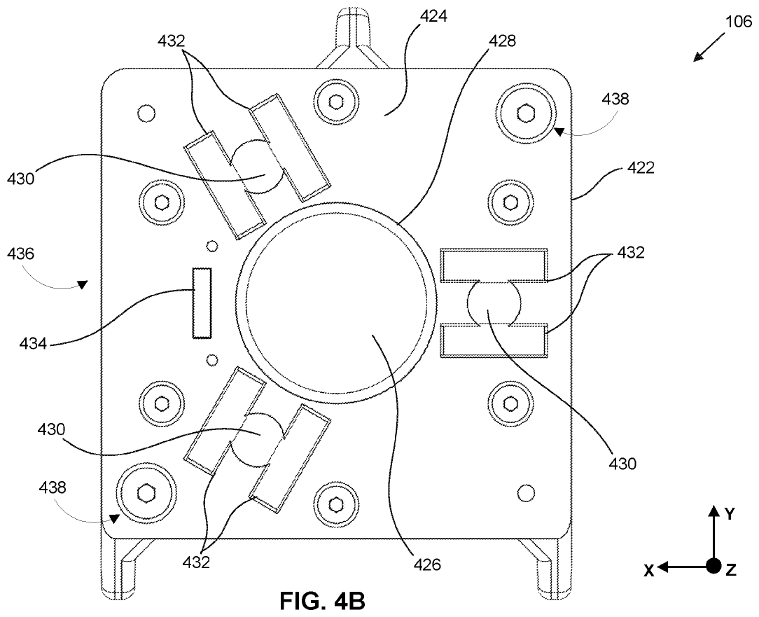

In some aspects, tool changer receiver 106 can be mounted to a top surface of modular tool 108. In some aspects, tool changer receiver 106 can be configured to receive electromagnetic tool changer 104 and removably detach from electromagnetic tool changer 104. In some aspects, tool changer receiver 106 can be equipped with a ferromagnetic element (such as a plate) to perform adhesion and alignment functions with electromagnetic tool changer 104 (as shown in and further described with respect to FIGS. 4A-4B and 5A-5B).

In some aspects, modular tool 108 can be a gripper, a pipettor, a magnetic mechanism, a suction mechanism, a lifter, or the like, for interaction with objects located on, within the volume of, or near the chassis supporting robot arm 102, such as plates, tubes, bowls, arrays, and the like. In one example aspect, as shown in FIG. 1, modular tool 108 can be a gripper tool. In some aspects, modular tool 108 can receive command signals from robot arm 102 for interaction with objects in a biological processing environment.

Prior robotic systems for biological processing environments only release modular tools through the use of manual mechanical triggers (e.g., pressing a clasp, unscrewing fasteners, etc.) or automatic electrical triggers (e.g., powering on a robot). As a result, a user could have difficulty removing a modular tool and an error scenario could damage the components of such a robotic system so as to require servicing of the entire robotic system under such circumstances.

In contrast, in some aspects, modular tool 108 can be configured to be manually detachable, via a human grip force, from electromagnetic tool changer 104 when tool changer receiver 106 is magnetically adhered to electromagnetic tool changer 104. For example, the strength of a permanent electromagnet contained within electromagnetic tool changer 104 may be set by a controller to have an electrical current at a predetermined threshold such that the permanent electromagnet can have a strength strong enough to lift the weight of objects commonly used in a biological processing system (e.g., about 10 kg to about 30 kg of lifting force), but weaker than a human grip force. In this configuration, a human grip force (e.g., about 20 kg of human grip force or analogous torqueing force) can overcome a magnetic field adhering modular tool 108 to electromagnetic tool changer 104. Therefore, a user can manually remove modular tool 108 without damaging any of the components, even if tool changer system 100 is powered off. For example, if a user wants to access and replace modular tool 108 (e.g., for the purpose of a repair, an upgrade, or a power failure mitigation), the user can simply remove modular tool 108 by hand as an improvement over prior robotic systems.

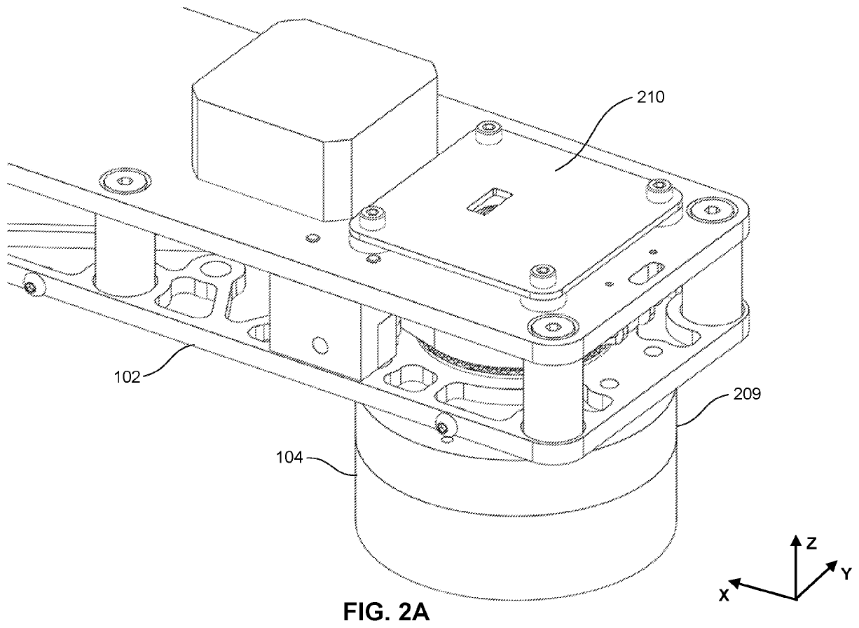

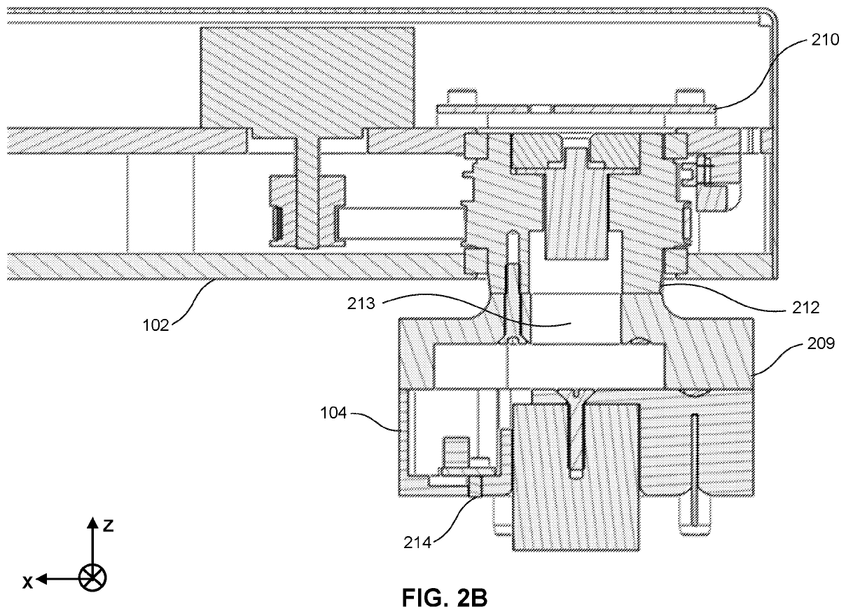

FIGS. 2A and 2B illustrate perspective and cross-section views, respectively, of electromagnetic tool changer 104 coupled to robot arm 102, according to some aspects. In some aspects, robot arm 102 can include a tool changer mount 209, a controller 210, and a rotating component 212.

In some aspects, as shown in FIG. 2A, robot arm 102 can be equipped with a tool changer mount 209. In some aspects, tool changer mount 209 can be disposed on a bottom surface of robot arm 102. In some aspects, tool changer mount 209 can be sized and shaped to support electromagnetic tool changer 104. For example, tool changer mount 209 can be a cylindrical shape that matches a cylindrically shaped electromagnetic tool changer 104, although any other set of complementary shapes is also contemplated. In some aspects, electromagnetic tool changer 104 can be coupled to tool changer mount 209. For example, electromagnetic tool changer 104 can be coupled to tool changer mount 209 with fasteners such as bolts, adhesive, magnets, clips, rotatable cams, and the like. In some aspects, electromagnetic tool changer 104 can be decoupled from tool changer mount 209 by removing the fasteners.

In some aspects, robot arm 102 can be equipped with a controller 210 configured to adjust an electrical current running through electromagnetic tool changer 104. In some aspects, the electrical current can affect a magnetic field produced by a permanent electromagnet within electromagnetic tool changer 104.

In some aspects, controller 210 can include an H-bridge circuit configured to control the electrical current running through electromagnetic tool changer 104. In some aspects, controller 210 can include an H-bridge circuit configured to direct the electrical current in a first direction to cancel the magnetic field. In some aspects, controller 210 can include an H-bridge circuit configured to direct the electrical current in a second direction to augment the magnetic field. In some aspects, controller 210 can include an H-bridge circuit configured to stop the electrical current to leave the magnetic field undisrupted. In some aspects, based on a user input, controller 210 can select between at least two of directing the electrical current in a first direction, directing the electrical current in a second direction, or stopping the electrical current. In some aspects, controller 210 may be controlled by instructions transmitted from a central processing system, as described in PCT Appl. Publ. WO 2023/173038, which is incorporated by reference herein in its entirety.

In some aspects, as shown in FIG. 2B, robot arm 102 can include rotating component 212. In some aspects, rotating component 212 can serve as a connection site on robot arm 102 for tool changer mount 209. In some aspects, rotating component 212 can be coupled to controller 210 by way of electrical wiring. Controller 210 can be configured to send a rotation command signal to rotating component 212 to produce a rotational motion. In some aspects, electromagnetic tool changer 104 can be coupled to rotating component 212 by way of tool changer mount 209. As a result, electromagnetic tool changer 104 can rotate when controller 210 sends a rotation command signal to rotating component 212. In some aspects, rotating component 212 is also configured to attach directly to a given tool without electromagnetic tool changer 104 and associated mounting components attached. In this way, the attachment mechanism for rotating component 212 can be universal between tool changer mount 209 and a tool 108.

In some aspects, tool changer mount 209 can include a wiring cavity 213 configured for storing electrical wiring that connects controller 210 to electromagnetic tool changer 104, thereby allowing controller 210 to power the permanent electromagnet within electromagnetic tool changer 104. In some aspects, the electrical wiring between controller 210 and electromagnetic tool changer 104 can pass through rotating component 212. In some aspects, rotating component 212 can include a slip ring configured to maintain the electrical current between the elements while rotating electromagnetic tool changer 104. Accordingly, rotating component 212 can allow electromagnetic tool changer 104 to rotate while still maintaining a stable electrical connection to controller 210.

In some aspects, tool changer electrical connector 214 can be coupled to controller 210 by way of electrical wiring located within wiring cavity 213. In some aspects, tool changer electrical connector 214 can receive input signals from controller 210 to operate a modular tool (e.g., modular tool 108 shown in FIG. 1). In some aspects, tool changer electrical connector 214 can establish a stable electrical connection with an electrical connector disposed on tool changer receiver 106 (as shown in and further described with respect to FIGS. 5A-5B) to transmit electrical data to modular tool 108. In some aspects, tool changer electrical connector 214 can be a pogo pin connector.

FIGS. 3A and 3B illustrate perspective and bottom surface views, respectively, of electromagnetic tool changer 104, according to some aspects. In some aspects, electromagnetic tool changer 104 can include tool changer electrical connector 214, permanent electromagnet 318, and tool changer alignment guides 320.

In some aspects, electromagnetic tool changer 104 can be coupled to robot arm 102 by mounting electromagnetic tool changer 104 on tool changer mount 209. For example, electromagnetic tool changer 104 can be coupled to tool changer mount 209 with fasteners such as bolts, adhesive, magnets, clips, rotatable cams, and the like. In some aspects, electromagnetic tool changer 104 can be decoupled from tool changer mount 209 by removing the fasteners. In some aspects, tool changer bottom surface 316 can be exposed for interfacing with tool changer receiver 106.

In some aspects, tool changer electrical connector 214 can protrude from tool changer bottom surface 316 to make contact with an electrical connector disposed on tool changer receiver 106 (as shown in and further described with respect to FIGS. 5A-5B).

In some aspects, electromagnetic tool changer 104 can include permanent electromagnet 318 configured to produce a magnetic field. In some aspects, permanent electromagnet 318 can magnetically adhere to ferromagnetic materials (e. g, steel). A permanent electromagnet is a non-standard configuration of electromagnet because permanent electromagnets are a hybrid of a permanent magnet and an electromagnet. With a standard electromagnet, power would need to be applied in order to keep a modular tool adhered to the electromagnet. If power is lost, then the adhesion force from the standard electromagnet will disappear, thereby dropping the modular tool.

In contrast to a standard electromagnet, in some aspects, permanent electromagnet 318 can be configured to have an undisrupted magnetic field with a strong adhesion force sufficient to support the weight of a modular tool (e.g., modular tool 108) without a power source. In some aspects, the strong adhesion force can be a tunable parameter. In some aspects, permanent electromagnet 318 can be configured to have multiple electromagnetic states depending on a characteristic of electric current supplied by controller 210, thereby tuning the strong adhesion force of permanent electromagnet 318. For example, permanent electromagnet 318 can have three electromagnetic states: (1) an undisrupted magnetic field based on the absence of electrical current, and therefore, a predetermined strong adhesion force; (2) a canceled magnetic field based on the electrical current running in a first direction, and therefore, no strong adhesion force; and (3) an augmented magnetic field based on the electrical current running in a second direction, and therefore, an augmented strong adhesion force.

In some aspects, instead of requiring power to adhere a modular tool (e.g., modular tool 108), permanent electromagnet 318 can use power to cancel out the magnetic field and therefore release the tool (e.g., modular tool 108). In this configuration, if a power failure occurs within tool changer system 100 while modular tool 108 is held by electromagnetic tool changer 104, modular tool 108 can remain adhered to electromagnetic tool changer 104 until power is restored and a cancelling field is applied to release modular tool 108.

In some aspects, augmenting the magnetic field of permanent electromagnet 318 can augment the strong adhesion force. For example, the strong adhesion force can be augmented by a factor of 2. In some aspects, the magnetic field of permanent electromagnet 318 can be augmented when robot arm 102 is in motion. In this configuration, augmenting the strong adhesion force of permanent electromagnet 318 can enable electromagnetic tool changer 104 to hold a tool in spite of dynamic loads when robot arm 102 is moving the tool.

The use of permanent electromagnet 318 in tool changer system 100 can allow the robotic system to operate with fewer parts, thus making the tool less complex, saving assembly time and reducing a likelihood of malfunction. Additionally, the use of permanent electromagnet 318 in tool changer system 100 can offer a desirable user experience in terms of preventing system damage and simplifying the tool replacement process.

In some aspects, electromagnetic tool changer 104 can include a plurality of tool changer alignment guides 320 protruding from electromagnetic tool changer 104 (e.g., tool changer bottom surface 316). In the example aspect shown in FIGS. 3A and 3B, electromagnetic tool changer 104 can include three tool changer alignment guides 320. In some aspects, the plurality of tool changer alignment guides 320 can be sized and shaped to fit into a kinematic mount. For example, the plurality of tool changer alignment guides 320 can include chamfered pins. In some aspects, the plurality of tool changer alignment guides 320 can include a metallic material (e. g, steel).

FIGS. 4A and 4B illustrate perspective and top surface views, respectively, of tool changer receiver 106, according to some aspects. In some aspects, tool changer receiver 106 can include a receiver body 422, a permanent electromagnet cavity 426, a ferromagnetic plate 428, a plurality of alignment guide receptacles 430, a receiver electrical connector 434, and a plurality of receiver alignment guides 438. While aspects herein refer to a ferromagnetic plate 428, a skilled artisan will recognize that any shape of ferromagnetic element may alternatively be used.

In some aspects, receiver body 422 can include a receiver top surface 424 and a receiver bottom surface 436. In some aspects, receiver body 422 can be manufactured from a plastic material (e.g., 3D-printed filament) or machined from a metal or non-metal block. In some aspects, receiver body 422 can include a plurality of holes for fastening components to receiver body 422.

In some aspects, receiver body 422 can include permanent electromagnet cavity 426 that is sized and shaped to receive a permanent electromagnet (e.g., permanent electromagnet 318). For example, permanent electromagnet cavity 426 can be sized and shaped such that there is a predetermined tolerable clearance between a diameter of permanent electromagnet cavity 426 and permanent electromagnet 318.

In some aspects, ferromagnetic plate 428 can be mounted on receiver bottom surface 436 such that a permanent electromagnet (e.g. permanent electromagnet 318) can make contact with ferromagnetic plate 428 when the permanent electromagnet is inserted through permanent electromagnet cavity 426. In some aspects, ferromagnetic plate 428 can magnetically adhere to the permanent electromagnet (e.g. permanent electromagnet 318) when the permanent electromagnet is activated. For example, ferromagnetic plate 428 can be manufactured from a ferromagnetic material (e.g., mild steel).

In some aspects, a plurality of alignment guide receptacles 430 can be disposed in receiver body 422 of tool changer receiver 106. For example, alignment guide receptacles 430 can be recessed within receiver body 422 of tool changer receiver 106. In some aspects, receiver body 422 of tool changer receiver 106 can include three alignment guide receptacles 430. In some aspects, the plurality of alignment guide receptacles 430 can be configured to receive a plurality of tool changer alignment guides (e.g., tool changer alignment guides 320). In some aspects, each alignment guide receptacle 430 can be configured to receive one of tool changer alignment guides 320.

In some aspects, each of the plurality of alignment guide receptacles 430 can include paired dowels 432 configured to perform rotational and translational alignment in at least one of an X-direction or a Y-direction. In some aspects, a first set of paired dowels 432 can perform rotational alignment and a second set of paired dowels 432 can perform translational alignment. In some aspects, paired dowels 432 can be manufactured from a metallic material (e.g., hardened steel).

In some aspects, each set of paired dowels 432 can be sized and shaped to receive one of tool changer alignment guides 320 (e.g., chamfered pins). For example, the cylindrical shape of paired dowels 432 can be configured to rotate and therefore push one of tool changer alignment guides 320 into one of alignment guide receptacles 430. Accordingly, the mating of tool changer alignment guides 320 and paired dowels 432 can serve as a pin-dowel configuration of a kinematic mount alignment system. A skilled artisan would appreciate that, in other aspects, alignment guide receptacles 430 need not include paired dowels 432. Rather, in some aspects, alignment guide receptacles 430 can be any other size or shape that complements a size and shape of tool changer alignment guides 320.

In some aspects, receiver electrical connector 434 can be configured to make contact with a complementary electrical connector. For example, receiver electrical connector 434 can establish a stable electrical connection with tool changer electrical connector 214. In this configuration, receiver electrical connector 434 can receive input signals via tool changer electrical connector 214 from controller 210 to transmit electrical data to a modular tool (e.g., modular tool 108) and operate modular tool 108. In some aspects, receiver electrical connector 434 can be a pogo pin connector. In some aspects, receiver electrical connector 434 can be a conductive plate configured to receive or otherwise abut a pogo pin connector.

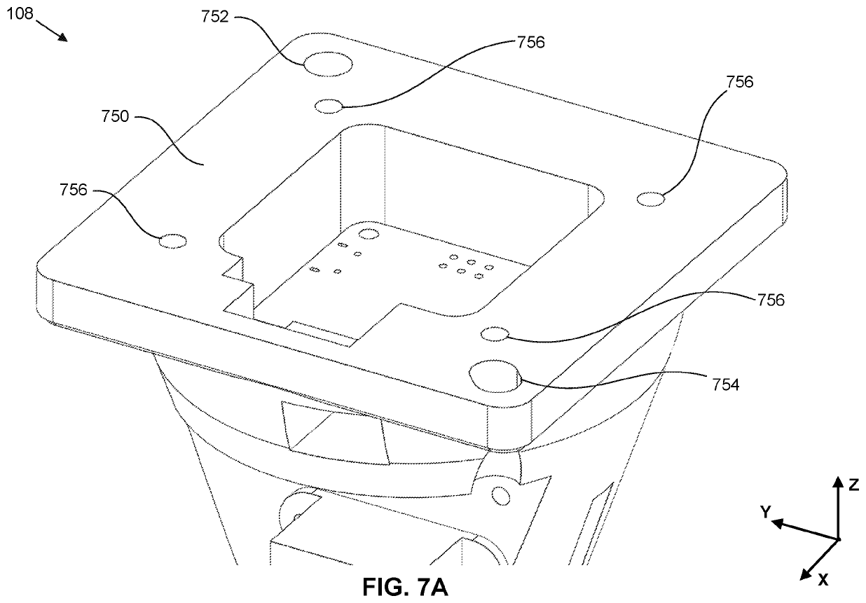

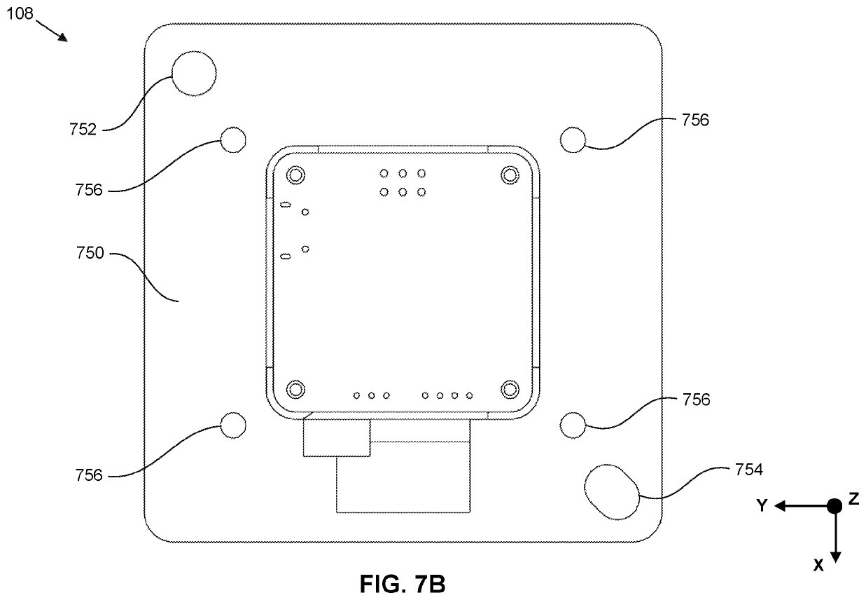

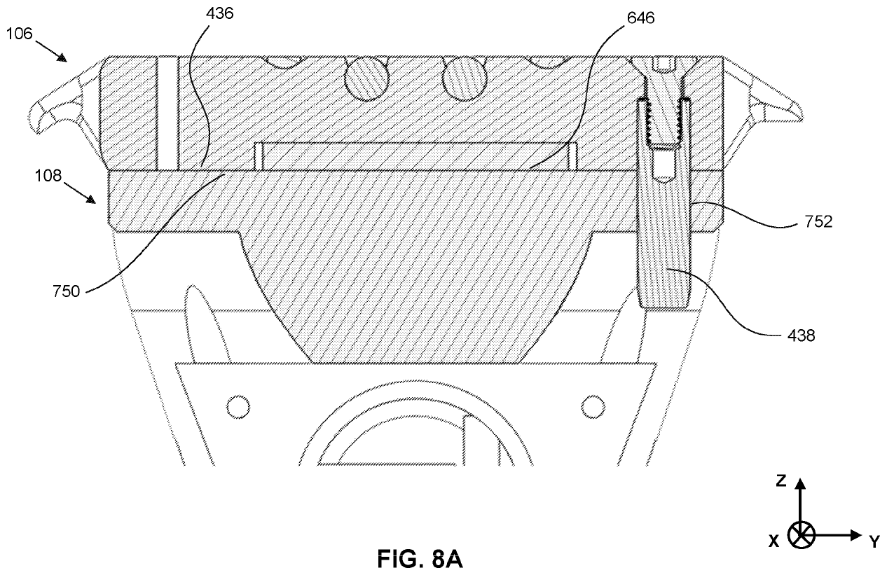

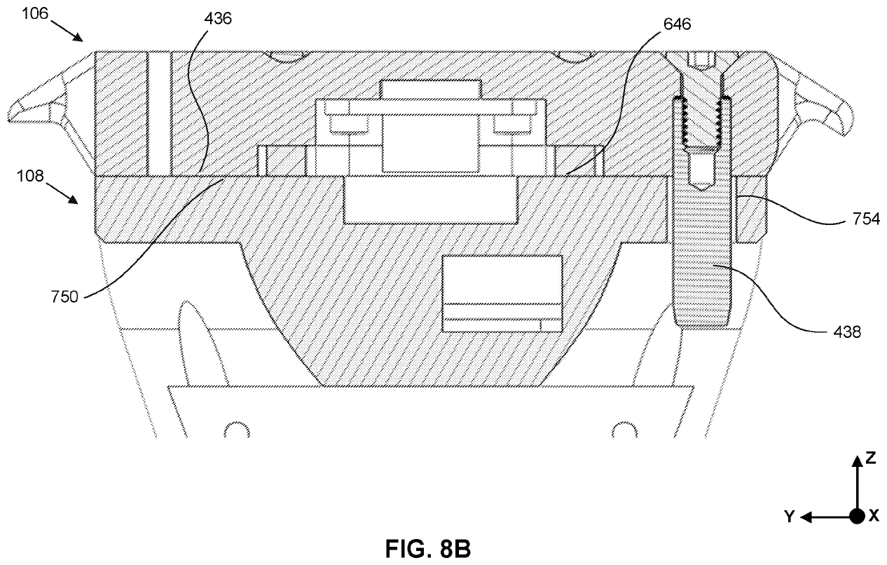

In some aspects, a plurality of receiver alignment guides 438 can protrude from receiver bottom surface 436 of tool changer receiver 106. In the example aspect shown in FIGS. 4A and 4B, tool changer receiver 106 can include two receiver alignment guides 438. In this configuration, each of the receiver alignment guides 438 can protrude from opposite corners of receiver bottom surface 436. It is understood that the top surface view of tool changer receiver 106 in FIG. 4B obstructs the full view of receiver alignment guides 438, which can extend in a Z-direction from receiver bottom surface 436. In some aspects, the plurality of receiver alignment guides 438 can be sized and shaped to fit into a hole-and-slot alignment system (as shown in and further described with respect to FIGS. 7A-7B, and 8A-8B). For example, the plurality of receiver alignment guides 438 can include chamfered pins. In some aspects, the plurality of receiver alignment guides 438 can include a metallic material (e.g, steel).

FIG. 5A illustrates a cross-section view of electromagnetic tool changer 104 mated with tool changer receiver 106, according to some aspects. In this configuration, the mating of electromagnetic tool changer 104 with tool changer receiver 106 illustrates electromagnetic adhesion system 540 and kinematic mount alignment system 542.

In some aspects, electromagnetic adhesion system 540 can include an adhesion interaction between permanent electromagnet 318 of electromagnetic tool changer 104 and ferromagnetic plate 428 of tool changer receiver 106. In some aspects, robot arm 102 can move electromagnetic tool changer 104, and therefore permanent electromagnet 318, toward receiver body 422 of tool changer receiver 106. During this motion, permanent electromagnet 318 can enter permanent electromagnet cavity 426 with a predetermined tolerable clearance between a diameter of permanent electromagnet 318 and permanent electromagnet cavity 426. Robot arm 102 can move electromagnetic tool changer 104, and therefore permanent electromagnet 318, until permanent electromagnet 318 makes contact with a ferromagnetic plate top surface 544 of ferromagnetic plate 428 disposed under permanent electromagnet cavity 426. Once permanent electromagnet 318 makes contact with ferromagnetic plate top surface 544, permanent electromagnet 318 can magnetically adhere to ferromagnetic plate 428. While permanent electromagnet 318 and ferromagnetic plate 428 are magnetically adhered, tool changer bottom surface 316 and receiver top surface 424 can be located adjacent to each other with a predetermined clearance. Accordingly, when electromagnetic tool changer 104 and tool changer receiver 106 are mated by electromagnetic adhesion system 540, robot arm 102 can hold and transport modular tool 108 without damaging any components of tool changer system 100.

Aspects of electromagnetic adhesion system 540 can provide numerous benefits over prior adhesion systems. Prior adhesion systems could be pneumatically driven, which requires an air pressure source to pressurize and depressurize the prior adhesion system when interacting with a tool. As a result, prior adhesion systems could be overly complicated by incorporating many expensive moving parts. In contrast, electromagnetic adhesion system 540 can provide a cost-effective system that uses few machined parts, thereby simplifying assembly and user operations.

In some aspects, kinematic mount alignment system 542 can include a plurality of tool changer alignment guides 320 and a plurality of alignment guide receptacles 430 configured to receive the plurality of tool changer alignment guides 320. It is understood that the cross-section view of FIG. 5A only shows one of the plurality of tool changer alignment guides 320 and a corresponding one of the plurality of alignment guide receptacles 430; however, other number and configurations of alignment guides and receptacles are nonetheless contemplated. In some aspects, kinematic mount alignment system 542 can align tool changer alignment guides 320 inside alignment guide receptacles 430 with a precision of a fraction of a millimeter. Additionally, in some aspects, electromagnetic tool changer 104 can be configured to align a modular tool (e.g., modular tool 108) in a Z-direction when ferromagnetic plate 428 is magnetically adhered to permanent electromagnet 318. A skilled artisan will recognize that other types of alignment guides and/or systems may alternatively or additionally be used.

Aspects of kinematic mount alignment system 542 can provide numerous benefits over prior alignment systems. Prior alignment systems could perform alignment between pins and spheres to address alignment in X-, Y-, and Z-directions, but the use of pin-sphere alignment could result in improper contact, or a lack of contact, between a prior adhesion system and a tool, thereby weakening the holding strength considerably. In contrast, kinematic mount alignment system 542 can offer an improvement over prior alignment systems by enabling permanent electromagnet 318 to perform precise alignment in a vertical Z-direction while a unique pin-dowel alignment between tool changer alignment guides 320 (e.g., chamfered pins) and alignment guide receptacles 430 (e.g., paired dowels 432) can perform alignment in X-and Y-directions. In this configuration, permanent electromagnet 318 can establish proper contact with ferromagnetic plate 428, and thus generate maximum holding force to support modular tool 108. The use of pin-dowel alignment can allow for the use of low-cost plastic body components (e.g., receiver body 422), while still permitting the use of sturdy metal alignment guides. Therefore, kinematic mount alignment system 542 can provide a cost-effective system that provides more precise alignment than prior alignment systems.

In some aspects, tool changer electrical connector 214 and receiver electrical connector 434 can be configured to make contact when permanent electromagnet 318 and ferromagnetic plate 428 are magnetically adhered. In some aspects, tool changer electrical connector 214 and receiver electrical connector 434 each can be a pogo pin connector configured with a spring to counteract any unwanted movement and therefore establish a stable electrical connection. In this configuration, the contact between tool changer electrical connector 214 and receiver electrical connector 434 can enable controller 210 to transmit electrical data to a modular tool (e.g., modular tool 108) and operate the modular tool.

FIG. 5B illustrates another cross-section view of electromagnetic tool changer 104 mated with tool changer receiver 106, according to some aspects. In this configuration, the mating of electromagnetic tool changer 104 with tool changer receiver 106 illustrates kinematic mount alignment system 542.

In some aspects, kinematic mount alignment system 542 can include a plurality of tool changer alignment guides 320 and a plurality of alignment guide receptacles 430 configured to receive the plurality of tool changer alignment guides 320. It is understood that the cross-section view of FIG. 5B only shows one of the plurality of tool changer alignment guides 320 and a corresponding one of the plurality of alignment guide receptacles 430; however, other numbers and configurations of alignment guides and receptacles are nonetheless contemplated. In some aspects, kinematic mount alignment system 542 can align tool changer alignment guides 320 inside alignment guide receptacles 430 with a precision of a fraction of a millimeter. In some aspects, each of the plurality of alignment guide receptacles 430 can include paired dowels 432 configured to perform rotational and translational alignment in at least one of an X-direction or a Y-direction. In this example configuration, one of the plurality of tool changer alignment guides 320 can be received by a corresponding set of paired dowels 432. In some aspects, paired dowels 432 can rotate along with the direction of movement of the tool changer alignment guides 320 to perform alignment as robot arm 102 moves electromagnetic tool changer 104 in a downward Z-direction. A skilled artisan will recognize that other types of alignment guides and/or systems may alternatively or additionally be used.

While aspects of tool changer 104 have been described herein as containing alignment guides 320 and aspects of tool changer receiver 106 have been described as containing alignment guide receptacles 430, a skilled artisan would recognize that such a configuration can be reversed, such that tool changer receiver 106 contains alignment guides while tool changer 108 contains alignment guide receptacles.

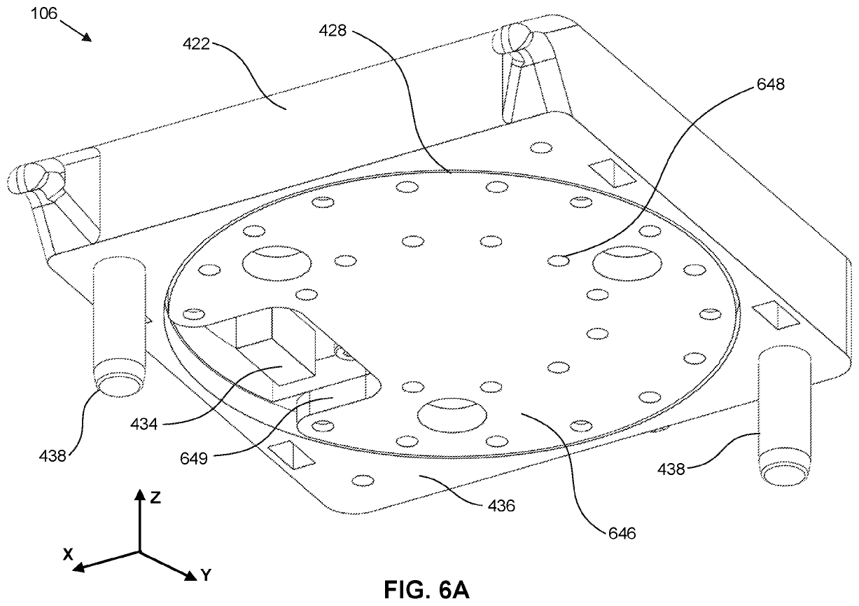

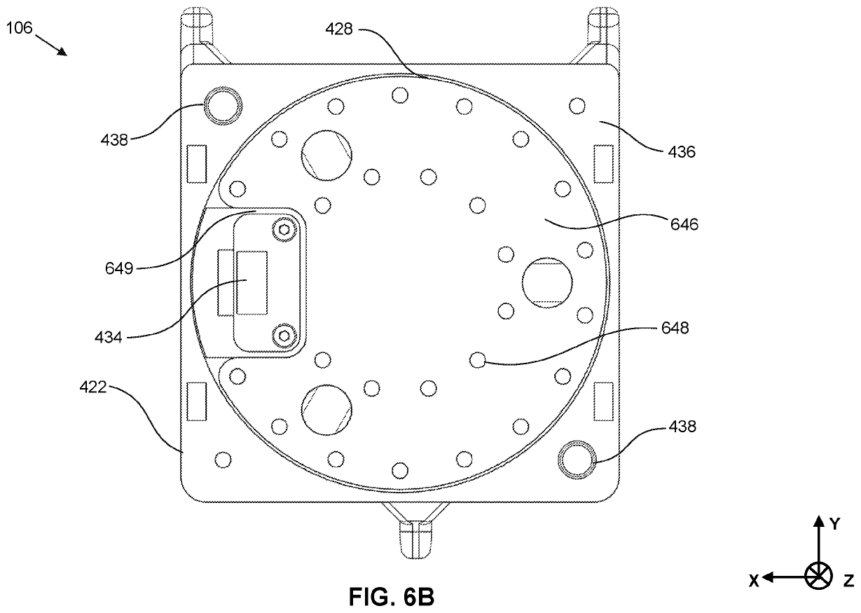

FIGS. 6A and 6B illustrate perspective and bottom surface views, respectively, of tool changer receiver 106, according to some aspects. In some aspects, receiver body 422 of tool changer receiver 106 can be sized and shaped to receive ferromagnetic plate 428. In some aspects, ferromagnetic plate 428 can be mounted within receiver body 422 such that a ferromagnetic plate bottom surface 646 of ferromagnetic plate 428 is flush with receiver bottom surface 436.

In some aspects, ferromagnetic plate 428 can include a plurality of mounting holes 648. In some aspects, the plurality of mounting holes 648 can be configured to receive fasteners such as bolts, adhesive, magnets, clips, rotatable cams, and the like. In some aspects, the plurality of mounting holes 648 can be used for mounting ferromagnetic plate 428 to receiver body 422, for mounting ferromagnetic plate 428 to a modular tool (e.g., modular tool 108), or for a combination of these. In this configuration, ferromagnetic plate 428 can be mounted to a modular tool (e.g., modular tool 108) at any mounting holes 648 not in use for mounting ferromagnetic plate 428 to receiver body 422. For example, a first half of the plurality of mounting holes 648 can be used for mounting ferromagnetic plate 428 to receiver body 422, while a second half of the plurality of mounting holes 648 can be used for mounting ferromagnetic plate 428 to a modular tool (e.g., modular tool 108).

In some aspects, ferromagnetic plate 428 can include a cutout 649. In some aspects, cutout 649 can be sized and shaped to enable electrical pass-through to modular tool 108 when modular tool 108 is mounted on tool changer receiver 106. For example, cutout 649 can be a rectangular shape to provide clearance for receiver electrical connector 434 to interface with electrical components coupled to modular tool 108, although any other set of complementary shapes is also contemplated.

FIGS. 7A and 7B illustrate perspective and top surface views, respectively, of modular tool 108, according to some aspects. In some aspects, modular tool 108 can include a tool top surface 750, at least one alignment guide hole 752, and a plurality of mounting sites 756. In some aspects, rather than including a plurality of alignment guide holes 752, modular tool 108 can include at least one alignment guide slot 754. For example, as shown in the aspect of FIGS. 7A and 7B, modular tool 108 can include a combination of at least one alignment guide hole 752 and at least one alignment guide slot 754.

In some aspects, modular tool 108 can be a gripper, a pipettor, a magnetic mechanism, a suction mechanism, a lifter, or the like, for interaction with objects such as plates, tubes, bowls, arrays, and the like. In one example aspect shown in FIGS. 7A and 7B, modular tool 108 can be a pipettor tool. In another example aspect shown in FIG. 1, modular tool 108 can be a gripper tool. In some aspects, modular tool 108 can receive command signals from robot arm 102 for interaction with objects in a biological processing environment, such as described in PCT Appl. Publ. WO 2023/173038, which is incorporated by reference herein in its entirety. In some aspects, modular tool 108 can be configured to be manually detachable, e.g. via a human grip force, from electromagnetic tool changer 104 when ferromagnetic plate 428 is magnetically adhered to permanent electromagnet 318.

In some aspects, modular tool 108 can be configured to receive a plurality of receiver alignment guides 438 protruding from tool changer receiver 106. For example, in some aspects, tool top surface 750 can include various recesses such as at least one alignment guide hole 752 and at least one alignment guide slot 754, together forming a hole-and-slot alignment system. In some aspects, alignment guide hole 752 can be configured to receive one of receiver alignment guides 438. In some aspects, alignment guide hole 752 can be a circular shape and can be configured to perform positional alignment of tool changer receiver 106. In some aspects, alignment guide slot 754 can be configured to receive one of receiver alignment guides 438. In some aspects, alignment guide slot 754 can be an oblong shape and can be configured to perform rotational alignment of tool changer receiver 106. In this configuration, modular tool 108 can be aligned with tool changer receiver 106 before fastening modular tool 108 and tool changer receiver 106 together.

In some aspects, modular tool 108 can include a plurality of mounting sites 756 for mounting modular tool 108 to tool changer receiver 106. In some aspects, mounting sites 756 can mount modular tool 108 directly to receiver body 422 of tool changer receiver 106. In some aspects, mounting sites 756 can mount modular tool 108 to ferromagnetic plate bottom surface 646 of ferromagnetic plate 428 on tool changer receiver 106. In some aspects, the plurality of mounting sites 756 can be configured to receive fasteners such as bolts, adhesive, magnets, clips, rotatable cams, and the like. In some aspects, mounting sites 756 of modular tool 108 can be aligned with mounting holes 648 of ferromagnetic plate 428 for inserting such fasteners.

FIGS. 8A and 8B illustrate cross-section views of tool changer receiver 106 mated with modular tool 108, according to some aspects. In some aspects, when tool changer receiver 106 and modular tool 108 are mated, alignment guide hole 752 can align a corresponding one of the plurality of receiver alignment guides 438 (as shown in FIG. 8A) and alignment guide slot 754 can align a corresponding one of the plurality of receiver alignment guides 438 (as shown in FIG. 8B) within a predetermined tolerable clearance. For example, both alignment guide hole 752 and alignment guide slot 754 can align the plurality of receiver alignment guides 438 with a precision of a fraction of a millimeter.

In some aspects, when tool changer receiver 106 and modular tool 108 are mated, both receiver bottom surface 436 and/or ferromagnetic plate bottom surface 646 can make contact with tool top surface 750 in an XY-plane. In some aspects, fasteners can be inserted along the XY-plane to couple tool changer receiver 106 and modular tool 108 together.

While aspects of tool changer receiver 106 have been described herein as containing receiver alignment guides 438 and aspects of modular tool 108 have been described as containing alignment guide holes 752 and/or slots 754, a skilled artisan would recognize that such a configuration can be reversed, such that modular tool 108 contains alignment guides while tool changer receiver 106 contains alignment guide holes and/or slots.

### Example Tool Changing Method

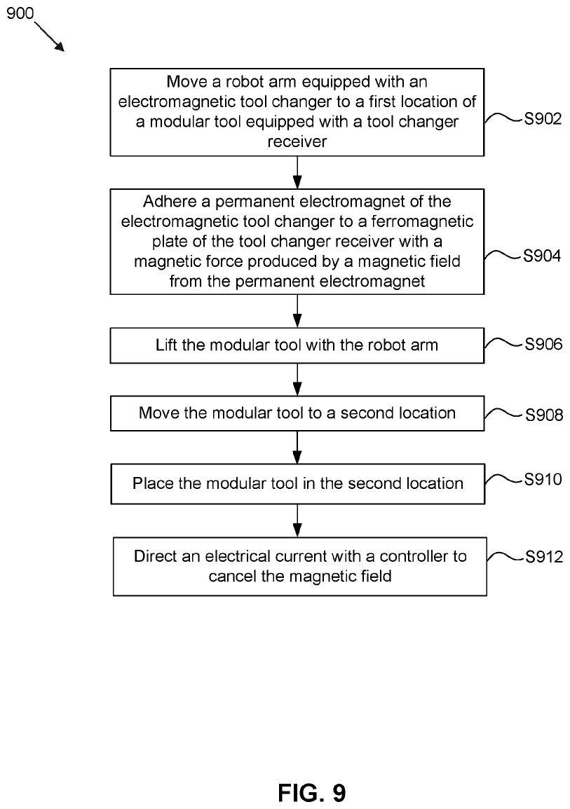

FIG. 9 illustrates a method 900 of changing a modular tool (e.g., modular tool 108), according to some aspects. In some aspects, at step S902, a robot arm (e.g., robot arm 102), equipped with an electromagnetic tool changer (e.g., electromagnetic tool changer 104) can move to a first location of a modular tool (e.g., modular tool 108) equipped with a tool changer receiver (e.g., tool changer receiver 106).

In some aspects, at step S904, a permanent electromagnet (e. g, permanent electromagnet 318) of the electromagnetic tool changer (e.g., electromagnetic tool changer 104) can adhere to a ferromagnetic element (e.g., ferromagnetic plate 428) of the tool changer receiver (e.g., tool changer receiver 106) with a magnetic force produced by a magnetic field from the permanent electromagnet (e. g, permanent electromagnet 318). In some aspects, adhering the permanent electromagnet (e. g, permanent electromagnet 318) to the ferromagnetic element (e.g., ferromagnetic plate 428) can further include aligning the modular tool (e.g., modular tool 108) in at least one of an X-direction, a Y-direction, or a Z-direction with tool changer alignment guides (e.g., tool changer alignment guides 320). In some aspects, such tool changer alignment guides include chamfered pins and a plurality of receptacles (e.g., alignment guide receptacles 430) comprising paired dowels (e.g., paired dowels 432).

In some aspects, at step S906, the modular tool (e.g., modular tool 108) can be lifted with the robot arm (e.g., robot arm 102). In some aspects, lifting the modular tool (e.g., modular tool 108) can further include directing an electrical current with a controller (e.g., controller 210) to augment the magnetic field prior to or concurrent with such lifting movement.

In some aspects, at step S908, the modular tool (e.g., modular tool 108) can be moved to a second location. In some aspects, moving the modular tool (e.g., modular tool 108) can further include directing an electrical current with a controller (e.g., controller 210) to augment the magnetic field prior to or concurrent with such movement.

In some aspects, at step S910, the modular tool (e.g., modular tool 108) can be placed in the second location.

In some aspects, at step S912, the electrical current can be directed with the controller (e.g., controller 210) to cancel the magnetic field, thus releasing the modular tool (e.g., modular tool 108) from the electromagnetic tool changer (e.g., electromagnetic tool changer 104).

In some aspects, at any point after step S904, the modular tool (e.g., modular tool 108) can be detached, via a human grip force, from the electromagnetic tool changer (e.g., electromagnetic tool changer 104) when the ferromagnetic element (e.g., ferromagnetic plate 428) is magnetically adhered to the permanent electromagnet (e. g, permanent electromagnet 318).

The method steps of FIG. 9 can be performed in any reasonable order and it is not required that all steps be performed. Moreover, the method steps of FIG. 9 described above merely reflect an example of steps and are not limiting. That is, further method steps and functions are envisaged based on aspects described in reference to FIGS. 1-8B.

It is to be appreciated that the Detailed Description section, and not the Summary and Abstract sections, is intended to be used to interpret the claims. The Summary and Abstract sections may set forth one or more but not all exemplary aspects of the present invention as contemplated by the inventor(s), and thus, are not intended to limit the present invention and the appended claims in any way.

The aspects have been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific aspects will so fully reveal the general nature of the invention that others can, by applying knowledge within the skill of the art, readily modify and/or adapt for various applications such specific aspects, without undue experimentation, without departing from the general concept of the present invention. Therefore, such adaptations and modifications are intended to be within the meaning and range of equivalents of the disclosed aspects, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary aspects, but should be defined only in accordance with the following claims and their equivalents.

1. A tool changer system comprising:
a robot arm comprising:
a controller configured to adjust an electrical current; and
a rotating component coupled to the controller;
an electromagnetic adhesion system comprising:
an electromagnetic tool changer coupled to the rotating component, wherein the electromagnetic tool changer comprises a permanent electromagnet configured to produce a magnetic field in an absence of the electrical current and cancel a produced magnetic field in response to a particular value of the electrical current, wherein the permanent electromagnet is sized and shaped for coupling with a tool changer receiver mounted to a modular tool; and
a kinematic mount alignment system comprising:
a plurality of tool changer alignment elements located on the electromagnetic tool changer, wherein the plurality of tool changer alignment elements are sized and shaped to couple with complementary alignment elements on the tool changer receiver.

2. The tool changer system of claim 1, wherein the controller comprises an H-bridge circuit configured to direct the electrical current in a first direction to cancel the magnetic field, to direct the electrical current in a second direction to augment the magnetic field, and to stop the electrical current.

3. The tool changer system of claim 1, wherein the rotating component comprises a slip ring configured to maintain the electrical current while rotating the electromagnetic tool changer.

4. The tool changer system of claim 1, wherein the electromagnetic tool changer is configured to align the modular tool in a Z-direction when the tool changer receiver is magnetically adhered to the permanent electromagnet.

5. The tool changer system of claim 1, wherein the controller is configured to set the electrical current at a predetermined threshold such that the modular tool is manually detachable, via a human grip force, from the electromagnetic tool changer when the ferromagnetic element is magnetically adhered to the permanent electromagnet.

6. The tool changer system of claim 1, further comprising the tool changer receiver, wherein the tool changer receiver comprises:
a ferromagnetic element;
a plurality of tool changer receiver alignment elements sized and shaped to couple with the plurality of tool changer alignment elements located on the surface of the electromagnetic tool changer; and
a plurality of modular tool mounting elements configured to mount to the modular tool, the plurality of modular tool mounting elements located on a side of the tool changer receiver opposite the plurality of tool changer receiver alignment elements.

7. The tool changer system of claim 6, wherein the ferromagnetic element is a ferromagnetic plate; and
wherein the plurality of modular tool mounting elements is located on a side of the ferromagnetic plate opposite a side of the ferromagnetic plate configured to couple to the permanent electromagnet of the electromagnetic tool changer.

8. (canceled)

9. The tool changer system of claim 6, wherein:
the plurality of tool changer alignment elements comprises a plurality of tool changer alignment guides protruding from a surface of the electromagnetic tool changer; and
the plurality of tool changer receiver alignment elements comprises a plurality of receptacles configured to receive the plurality of tool changer alignment guides.

10. The tool changer system of claim 9, wherein the plurality of tool changer alignment guides comprises chamfered pins, and the plurality of receptacles comprises paired dowels configured to perform rotational and translational alignment in at least one of an X-direction or a Y-direction.

11. The tool changer system of claim 6, further comprising the modular tool;
wherein the modular tool mounting elements on the tool changer receiver comprise a plurality of alignment guides protruding from the tool changer receiver;
wherein the modular tool comprises a plurality of alignment guide receptacles sized and shaped to receive the plurality of alignment guides protruding from the tool changer receiver; and
wherein the plurality of alignment guide receptacles of the modular tool comprises a hole and a slot, both the hole and the slot configured to receive a corresponding one of the plurality of alignment guides protruding from the tool changer receiver.

12. (canceled)

13. (canceled)

14. A biological sample processing system comprising the tool changer system of claim 1.

15. The biological sample processing system of claim 14, further comprising:
a chassis defining a volume in which the robot arm is configured to operate; and
a deck platform within the volume configured to hold biological sample processing equipment.

16. The biological sample processing system of claim 14, wherein the modular tool comprises at least one of: a gripper, a pipettor, a magnetic mechanism, a suction mechanism, or a lifter.

17. The biological sample processing system of claim 15, wherein the chassis further comprises a tool storage support sized and shaped to store one or more modular tools when not in use by the robot arm.

18. A method comprising:
moving a robot arm equipped with an electromagnetic tool changer to a first location of a modular tool equipped with a tool changer receiver;
adhering a permanent electromagnet of the electromagnetic tool changer to a ferromagnetic element of the tool changer receiver with a magnetic force produced by a magnetic field from the permanent electromagnet in an absence of an electrical current;
lifting the modular tool with the robot arm;
moving the modular tool to a second location;
placing the modular tool in the second location; and
directing an electrical current with a controller to cancel the magnetic field.

19. The method of claim 18, wherein the lifting the modular tool further comprises directing the electrical current with the controller to augment the magnetic field.

20. The method of claim 18, wherein the moving the modular tool further comprises directing the electrical current with the controller to augment the magnetic field.

21. The method of claim 18, wherein the adhering the permanent electromagnet further comprises aligning the modular tool in a Z-direction when the tool changer receiver is magnetically adhered to the ferromagnetic element.

22. The method of claim 18, wherein the adhering the permanent electromagnet further comprises aligning the modular tool in at least one of an X-direction or a Y-direction with tool changer alignment guides comprising chamfered pins and a plurality of receptacles comprising paired dowels.

23. The method of claim 18, further comprising detaching the modular tool, via a human grip force, from the electromagnetic tool changer when the ferromagnetic element is magnetically adhered to the permanent electromagnet.

24. (canceled)

25. (canceled)
